(19) United States
(12) Patent Application Publication
(10) Pub. No.: US 2021/0136529 A1
(43) Pub. Date: May 6, 2021

(54) METHOD FOR CONTROLLING A DATA TRANSFER, MOBILE DEVICE, AND VEHICLE WITH CONTROLLER FOR A DATA TRANSFER

(71) Applicant: ZF FRIENDRICHSHAFEN AG, Friedrichshafen (DE)

(72) Inventors: Georg Schneider, Urbar (DE); Boris Pradarutti, Mulheim-Karlich (DE)

(21) Appl. No.: 17/082,122

(22) Filed: Oct. 28, 2020

(30) Foreign Application Priority Data
Oct. 30, 2019 (DE) 10 2019 216 728.4

(51) Int. Cl. H04W 4/029; H04W 4/02; H04W 4/40; G01C 21/34

(52) U.S. Cl. CPC H04W 4/029; G01C 21/3453; H04W 4/40; H04W 4/027

(57) ABSTRACT

A method for controlling a data transfer for a mobile device (200) is described, wherein the method comprises: detecting (S10) a movement path of the mobile device (200); ascertaining (S20) at least one parameter for a data transfer connection (255) along the movement path of the mobile device (200); creating (S30) a parameter profile for each of the at least one parameter, wherein the parameter profile comprises a plurality of parameter values as a function of a position along the movement path and/or depending on a future point in time; and triggering (S40) an event as a function of the parameter profile. In addition, a mobile device (200) and a vehicle (1) for carrying out such a method are described.

### BACKGROUND

A method for controlling a data transfer, a mobile device that can carry out such a method, and a vehicle with such a mobile device are described. In particular, a method, a mobile device, and a vehicle are described, wherein a parameter profile for a data transfer connection along a movement path is ascertained and evaluated and an event is triggered as a function of the parameter profile.

Conventional navigation systems or similar devices, which follow a specific movement path, are usually dependent on an existing data transfer connection if updated data are required during movement. If a data transfer connection is not available, these systems and devices usually switch to an offline mode in which locally stored information is used.

### Object of the Invention

There is a need for an improvement in mobile connectivity of a mobile device, in particular in mobile data connectivity.

### Proposed Solution

This technical object is achieved by a method with the features of claim 1, a mobile device with the features of claim 10, and a vehicle with the features of claim 11. Advantageous embodiments are defined by the further claims.

According to a first aspect, for a better understanding the present disclosure, a method for controlling a data transfer for a mobile device comprises the following steps. First, a movement path of the mobile device is detected. This can be a planned route between a starting point and a destination point, which was calculated by a route planning system, or a so-called electronic horizon that estimates the movement path along which the mobile device will move.

In the next steps, at least one parameter for a data transfer connection along the movement path of the mobile device is ascertained and a parameter profile is created for each of the at least one parameter. A parameter profile can include a multiplicity of parameter values as a function of a position along the movement path and/or depending on a future point in time. In other words, the parameter profile maps all parameter values depending on a (future) location and/or point in time. A separate parameter profile can be created for each parameter.

Even if a data transfer connection is mentioned in this case, the method can equally be used for other connections, for example a voice connection. The term “data transfer connection” is therefore synonymous in the present disclosure with a connection between the mobile device and another device (for example network component).

Finally, in a further step, an event is triggered as a function of the parameter profile. Since the parameter profile comprises future parameter values of the data transfer connection, various events can be triggered as a function of an expected parameter value at a specific location and/or at a specific point in time. As a result, on the one hand, the system carrying out such a method can react early to the corresponding parameter values of the data transfer connection and/or inform a user of such a system about the parameters of the data transfer connection.

In one embodiment variant of the method, a parameter profile can be used to verify whether one of the plurality of parameter values in the parameter profile is below a threshold value (or optionally equal to the threshold value). This verification can be carried out separately for each parameter profile, i.e., for each parameter. Since most of the parameters of the data transfer connection mean an unsatisfactory, insufficient or no data transfer connection at low parameter values, a verification is made to ascertain whether the threshold value has been undershot. Of course, a verification for exceeding the threshold value can also take place if this means that, in the case of a parameter value above the threshold value, the data transfer connection works poorly or not at all.

In a further embodiment variant, the triggering of the event can take place at a point in time when the mobile device reaches a position along the movement path associated with the parameter value lying below the threshold value. However, this is not to be understood as an exact point in time at which the mobile device precisely reaches the position. Rather, the triggering of the event can also take place within a predetermined time span before the position is reached. For example, the event can be triggered a few seconds (2, 5, 10, 20 seconds, etc.), or a few minutes (1, 2, 5 minutes, etc.) before reaching the position or shortly before or at the start of a movement of the mobile device. The time span can optionally be dependent on a speed of the mobile device. For example, the faster the mobile device moves, the larger the time span can be selected. Likewise, the point in time for triggering the event can be selected as a function of a distance between the mobile device and the position along the movement path associated with the parameter value lying below the threshold value. This can also be made dependent on a speed of the mobile device. The event can be triggered 50, 100, 200, 500 m, 1, 2, 5, 10 km before the position is reached.

Alternatively or additionally, the event can be triggered prior to the future point in time associated with the parameter value below the threshold value. For this, it is either necessary to create the parameter profile (among other things) as a function of time (i.e., to save the parameter values in the parameter profile with a future point in time when the parameter value will occur) or to create the parameter profile as a function of a location and additionally ascertain a speed profile of the mobile device. In this way, the future point in time can be calculated (or at least estimated) when the parameter value will be below the threshold value. Accordingly, the event can be triggered a few seconds (2, 5, 10, 20 seconds, etc.) or a few minutes (1, 2, 5 minutes, etc.) before this future point in time.

In yet another embodiment, the event can be triggered when the parameter value is below the threshold value. On the one hand, this option allows the triggering of the event when the parameter value according to the parameter profile has been reached (corresponds to a time span equal to zero), or if, in deviation from the parameter profile, the actual parameter value falls below the threshold value. The method can thus also take into account that an actual parameter value does not necessarily have to follow the parameter profile, but rather can vary due to other (external) influences.

In various embodiment variants, the at least one parameter can include a transmission standard, a mobile network provider, a maximum data transmission speed, a transmission quality, a signal strength, and/or costs of the data transfer connection. If such a parameter falls below a predetermined threshold value, data transmission is no longer possible, depending on the bandwidth required, or it becomes too costly.

Transmission standards and mobile radio providers can also be sorted accordingly, so that a minimum transmission standard or specific mobile network providers are necessary in order to achieve the required bandwidth or low costs. In other words, if the parameter “transmission standard” or “mobile network provider” is below a specified threshold value (e.g., at least 4G), the event can be triggered.

The transmission standard includes, for example, all mobile radio standards (2G, 3G, 4G, LTE, 5G, etc.), standards of a wireless local network (IEEE 802.11 xx, WiMax, etc.), message transmissions (SMS, MMS, etc.), satellite radio, local transmission standards (NFC, DSRC (Dedicated Short Range Communication), Bluetooth, etc.), and/or vehicle communication options (Car2Car communication, Car2lnfrastructure communication, Car2Cloud communication, Car2Pedestrian communication, C-ITS (Cooperative Intelligent Transport Systems) standards, etc.). Transmission quality can be understood, for example, as the proportion of error-free data transmission, the number of data packets not lost, etc.

In another embodiment variant, the event can include activating a data transfer to or from the mobile device. A data communication device can thus be activated in a simple embodiment. Such an activation takes place, for example, when the parameter profile indicates that the mobile device is at a location or at a point in time at which a data transfer connection is possible. Otherwise, the data communication device is deactivated, as a result of which energy can be saved.

In a somewhat more complex embodiment, a data communication device can be activated and data can be transmitted to the mobile device (downloaded) that the mobile device needs at a time during which the parameter profile specifies a poor or no data transfer connection at all. In other words, the method can allow predictive downloading of data. For example, map data (such as map tiles (“tiles”)) can be downloaded for a route planning system along which the mobile device moves and for which the parameter profile comprises parameter values that represent a poor or no data transfer connection. Furthermore, data for advanced driver assistance systems (ADAS) can be downloaded in advance in order to bridge the distance and/or time of a poor or no data transfer connection at all (for example, data representing the minimum distances for an adaptive cruise control (ACC)). Multimedia content (e.g., video, music, audiobooks, etc.) can also be downloaded in advance. For this embodiment, any buffer storage that may be present can also be increased so that the phase of poor or no data transfer connection can be bridged.

Alternatively or additionally, the event can comprise outputting a notification to a user of the mobile device. Such a notification can also be issued with a specified time interval before the “poor” parameter value is reached. For example, such a notification about the planned route and/or time with or without a data transfer connection can be displayed to the user. For this purpose, the notification to the user can include information for the user of the mobile device about the parameter profile, and in particular about the parameter values as a function of the movement path and/or the time. Further information from the parameter profile can also be displayed to the user, for example the location-related and/or time-related available standard, data transmission speed, transmission quality, signal strength, and/or costs of the data transfer connection. The notification to the user can include information for the user of the mobile device that the parameter values will be below a threshold value within a predefined future portion of the movement path and/or a predefined future time span. The notification can take place via any user interface; reference is only made to a display and a loudspeaker of the mobile device by way of example. Of course, output units of a device coupled to the mobile device can also be used as a user interface for outputting the notification.

Another embodiment, in which a notification is output to the user of the mobile device, can include an automatic notification of the user about an expected disconnection. This makes it possible to verify in the method whether a service and/or program is currently running on the mobile device that requires a connection. For example, it can be determined whether the user is currently making a phone call, streaming data over the Internet, or the like, whereby a continuous voice/data transfer connection is necessary. In this embodiment, a time span between outputting the notification and reaching the location and/or the time at which the connection becomes poor (not sufficient) can be selected to be shorter. For example, the user can still be given time to end or pause the phone call, data transfer, etc., while in the case of other notifications it is necessary to select a longer time span in order to show the user detailed information on the parameter profile, for example.

As an alternative or in addition, the event can also comprise sending a message to a route planning module that ascertains the movement path of the mobile device. In a simple embodiment, the route planning module can output at least one of the notifications described above to the user via its user interface. In a more extensive embodiment, the route planning module can recalculate the movement path of the mobile device in order to avoid the parameter profile having a parameter value below the threshold value. In other words, the route planning module can calculate a movement path that bypasses a dead zone or a location with a “poor” connection. In this case, the route planning module can optionally offer the user options as to whether the movement path (the route) should be recalculated or not and/or on the basis of which user preferences the movement path should be recalculated.

Furthermore, as an alternative or in addition, the event can comprise sending a message to a server, the message comprising at least part of the parameter profile. The server can be, for example, a network device of a radio network operator, a central traffic control center, a map data provider, or a similar centrally operating institution. This allows parameter profiles of a large number of mobile devices to be evaluated in order to improve services based on them.

Furthermore, the event can alternatively or additionally comprise activating a buffer storage which is designed to temporarily store data to be sent by the mobile device. These data to be temporarily stored can be, for example, movement patterns, sensor data (for example, in the case of a vehicle, sensor data from a camera, radar, lidar, ADAS component, etc.), or parameter values detected by the mobile device (actually available transmission standard, mobile network provider, data transmission speed, transmission quality, signal strength, etc.). As soon as the data transfer connection has reached a specific level again (at least one parameter value is above the threshold value), the buffered (temporarily stored) data can be transmitted.

Furthermore, the mobile device can verify the current availability of a mobile connection (data transfer connection) including its standard, provider, quality, signal strength, etc., ascertain deviations from the parameter profile, and transmit the corresponding data to a central entity. The measured parameter values (or entire parameter profiles) and/or the deviations from the parameter profiles can be transmitted to the central instance. If necessary, the parameter values for the parameter profile come from the central instance so that the parameter values can be updated there.

Finally, the event can also alternatively or additionally include sending a message to a system service. The system service can react with a passive notification or an active notification about the unavailability of the mobile device. In one embodiment variant, the system service can indicate the unavailability of the user of the mobile device after receiving the message.

A system service is, for example, a service for telephony, i.e., a program or an application for making a telephone call. This service can be designed in such a way that, when the message is received, it outputs a warning that the service may have to end a telephone call or cannot start a telephone call. A system service can also relate to a mailbox or an answering machine (a separate mailbox service or the mailbox of a telephony service, or an answering machine accessible via a network). When the message is received, for example, an announcement of the mailbox/answering machine can be adjusted automatically (for example: “This connection can be reached again by phone in X minutes”). For this purpose, it is advantageous if the message comprises data from the parameter profile, such as the above-mentioned duration of the unavailability of X minutes, after which a connection is sufficient again for a telephone call.

Alternatively or additionally, the system service can be a calendar. For this purpose, the calendar can be designed in such a way that it enters a (passive) out of office notice in the calendar after receiving the message. The calendar service can also trigger an active notification, for example in the form of an automatic cancellation of an appointment. An appointment for a conference call can be canceled or postponed in the case of unavailability of the mobile device for the scheduled appointment.

Further system services can be an e-mail service, text message service, and a corresponding communication service in social media. After receiving the message from the corresponding system service, a passive notification in the form of an absence setting for incoming messages (also known as “out-of-office” notification) can be made and/or an active notification in the form of an e-mail, messenger message (SMS, WhatsApp, etc.) or an absence entry on a social media platform (Facebook, Instagram, LinkedIn, etc.) can be triggered.

A similarly functioning system service is, for example, a vehicle fleet service in which a large number of vehicles are connected to one another and/or via a central server (Car2Car communication, Car2Cloud communication). This can inform other vehicles or the central server with the message about the unavailability. Conversely, the mobile device (for example, using the SENSORIS protocol) can be prompted before an unavailability to collect specific data in the area of the unavailability, to buffer these data and then to send them (if the data transfer connection is re-established). Vehicles can also be instructed by a central server (for example a traffic control center) to use alternative routes on which there is better accessibility (better data transfer connection).

Finally, the system service can also be coupled to the data communication device. Such a system service can cause the data communication device to switch to an alternative communication channel (different transmission standard, different provider, etc.). In this case, network devices connected to the data communication device can also be informed about such a change in the communication channel.

In a further embodiment variant, the system service can be configured by a user. For example, the user can set to whom specific (passive or active) notifications are sent. For example, family members or colleagues from a specific (hierarchical) position can see all absences in a specific (future) period, while acquaintances or other colleagues can only receive specific information about the current status. The frequency of active notifications can also be set. For example, notification of a planned trip can be made 1 hour, one day, etc. before or at the start of the trip. It is also possible for the system service to be set automatically. For example, a (passive or active) notification can take place as a function of a probability that the mobile device will not be available and contain this probability and/or the unavailability. For example, it can be communicated via the system service that the user of the mobile device “will most likely be unavailable for half an hour in 10 minutes” or “the employee XY will be unavailable for 1 hour tomorrow afternoon with a probability of 50%.”

Alternatively or additionally, the user can also configure the sending of a message to a system service. The user can select the system service to which a message is sent. The user can also set whether parameter values from the parameter profile or the entire parameter profile are transmitted to the system service in the message.

In another embodiment variant, detecting a movement path can comprise calculating a probability that the mobile device will move along a potential movement path at a specific future point in time. The method for the potential movement path can be terminated when the calculated probability is less than a threshold value. The potential movement path is ascertained on the basis of general map data and/or on the basis of previously stored movement profiles of the mobile device. Such a potential movement path is also known as an electronic horizon in vehicles. Thus, the method can be carried out not only for a movement path that runs between an entered starting point and destination point, but also for a possible movement path in the immediate surroundings of the mobile device.

In yet another embodiment variant, ascertaining at least one parameter for the data transfer connection along the movement path comprises obtaining extended map data, wherein the extended map data contain location-related and/or time-related parameter values for the at least one parameter. For example, extended map data can be stored in the mobile device or made available to the mobile device via a data transfer connection. Obtaining the extended map data can take place on the basis of the geographical location of the (potential) movement path. The extended map data may have been created at an earlier point in time through corresponding measurements.

According to a further aspect, for a better understanding of the present disclosure, a mobile device comprises a data communication device which is designed to carry out a data transfer on the basis of at least one transmission standard. Furthermore, the mobile device comprises a control unit which is designed to carry out the method according to the first aspect.

According to yet a further aspect, for a better understanding of the present disclosure, a vehicle comprises such a mobile device. Of course, the vehicle itself can also be equipped with a data communication device and a control unit which is designed to carry out the method according to the first aspect. In other words, the components of the mobile device can also be permanently installed in the vehicle.

The aspects, variants, and embodiments described above can be combined independently of the combinations described and regardless of the sequence described. Aspects, variants, and implementation options that are not explicitly described are thus also included in the present disclosure.

### BRIEF DESCRIPTION OF THE DRAWINGS

Further objectives, features, advantages, and possible applications result from the following description of embodiments, to be understood as non-restrictive, with reference to the associated drawings. Thereby, all described and/or illustrated features, on their own or in any combination, show the object disclosed here, also independently of their grouping in the claims or their dependencies. The dimensions and proportions of the components shown in the drawings are explicitly not to scale.

FIG. 1 schematically shows a flowchart of a method for controlling a data transfer.

FIG. 2 schematically shows a mobile device for controlling a data transfer.

FIG. 3 schematically shows a vehicle with a mobile device according to FIG. 2.

### DETAILED DESCRIPTION OF THE DRAWINGS

Comparable or identical and equally effective components and features are marked with the same reference signs in the drawings. In some cases, reference signs of individual features and components have been omitted in the drawings for reasons of clarity, although these features and components are already provided with reference signs in other drawings. The components and features, which are not described again in relation to the further drawings, are similar in their formation and function to the corresponding components and features according to the other drawings.

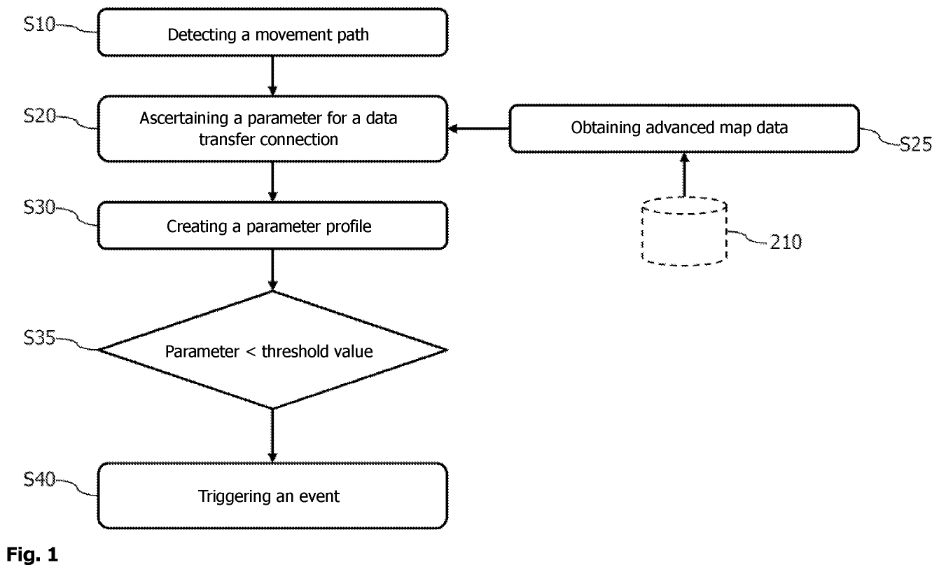

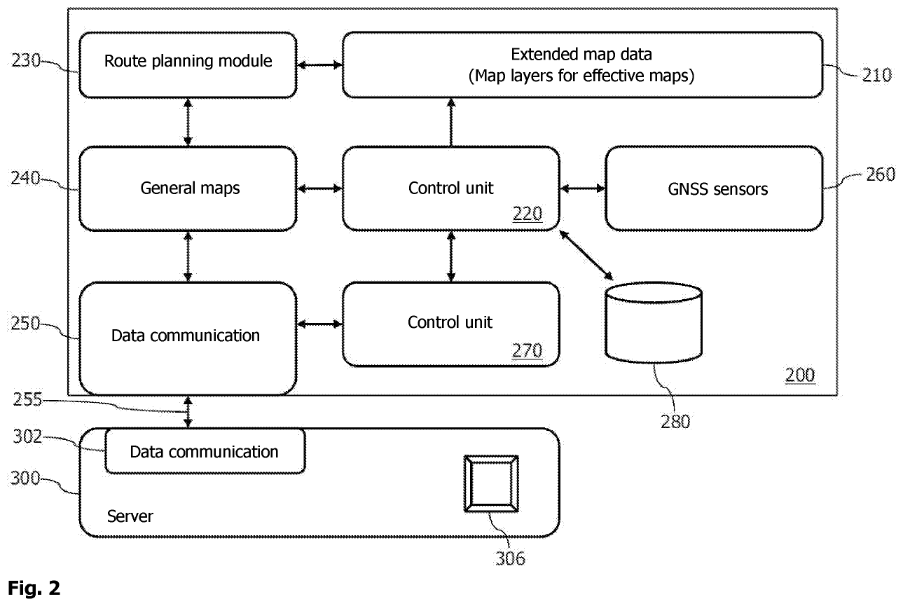

FIG. 1 schematically shows a flowchart of a method for controlling a data transfer. In a first step S10, a movement path of a mobile device 200 (see FIG. 2) is detected. The movement path can be a calculated route between a starting point and a destination point or, alternatively, an electronic horizon, i.e., a movement path along which the mobile device 200 is very likely to move.

In a further step S20, at least one parameter is ascertained for a data transfer connection 255 along the movement path. The parameter can be a transmission standard, a provider, a maximum data transmission speed, a transmission quality, a signal strength, costs of the data transfer connection 255, etc. The ascertaining of the at least one parameter can include obtaining S25 extended map data 210. The extended map data are location-related and/or time-related parameter values for the at least one parameter that were detected (measured) in advance and stored in the extended map data 210.

For each of the at least one parameter, a parameter profile is created in step S30. The parameter profile comprises, for example, a number of parameter values as a function of a position along the movement path and/or as a function of a future point in time. The parameter profile can comprise a parameter value at a specific position or a parameter value at a specific point in time. In other words, the parameter profile represents a diagram with a path axis, and/or time axis, and a series of parameter values on this/these axis/axes. The one or more parameter profiles thus allow conclusions to be drawn about a future data transfer connection 255.

In an optional step S35, it can now be verified whether one of the plurality of parameter values in the parameter profile (or in each of the parameter profiles) is below an associated threshold value. If a parameter value is below the threshold value, a poor data transfer connection and/or a disconnection can be assumed.

In any case, an event is triggered in step S40 as a function of the parameter profile created. The triggering event can be activating a data transfer, outputting a notification to a user, sending a message, and/or activating a buffer storage 280.

FIG. 2 schematically shows a mobile device 200 for controlling a data transfer. For this purpose, the mobile device 200 comprises at least one storage 210 which is designed to store extended map data, for example in the form of at least one map layer. A map layer comprises at least geographically and/or temporally assigned surroundings information of a specific type, such as network coverage for a cellular network and/or mobile data transmission. Each map layer can, for example, be assigned to a specific parameter for a data transfer connection 255 (for example via a data communication device 250) and contain location-related and/or time-related parameter values. The transmission standard, provider (of the network), maximum data transmission speed, transmission quality, signal strength, and/or costs of the data transfer connection 255 are possible parameters and thus categorization of a map layer.

General map data 240 representing a traffic route network can also be stored in the mobile device 200. These general map data can be customary map data used in navigation systems. Alternatively, the general map data 240 are integrated into the extended map data 210 as at least one further (basic) map layer.

The mobile device 200 can further comprise a route planning module 230, which detects or calculates a movement path of the mobile device based on the general map data 240. Either an entry of the starting point and destination point of a route to be calculated or an electronic horizon (i.e. a potential movement path) is used for this. For example, a satellite-based location technology can be used to determine a current position of the mobile device 200. For this purpose, the mobile device 200 has a sensor system 260 for a global navigation satellite system (GPS, Galileo, etc.).

A control unit 220 of the mobile device 200 (or alternatively the route planning module 230) can now ascertain at least one parameter for a data transfer connection 255 along the movement path. For example, the control unit 220 can read out the at least one parameter from the expanded map data 210. A parameter profile is then created for each of the at least one parameter, wherein the parameter profile comprises a plurality of parameter values as a function of a position along the movement path and/or depending on a future point in time. The future point in time is, for example, a point in time at which the mobile device is (very likely) at a specific location (for example along the movement path). Alternatively or additionally, the future point in time is a point in time in the future at which the mobile device 200 is indeed at the same location, but surroundings conditions in the environment of the mobile device change, which can have an influence on parameter values. For example, the mobile device can be located in a stadium or similar location for events, to which more and more people and thus further mobile devices 200 are coming. As a result, a parameter value (such as a maximum data transmission speed, transmission quality, signal strength, etc.) can change significantly at a future point in time (for example, at an event).

The control unit 220 can trigger an event with the aid of the at least one parameter profile. The event is therefore dependent on a current and an expected data transfer connection 255. For example, the control unit 220 can activate or deactivate a data transfer to or from the mobile device 200. For this purpose, the data communication device 250 can be activated or deactivated. Further events are outputting a notification to a user of the mobile device 200, sending a message to a route planning module 230, sending a message to a system service 270, and/or activating a buffer storage 280 which is designed to temporarily store data to be sent by the mobile device 200.

The system service 270 is shown as part of the mobile device 200. However, this is only one option. The system service 270 can also be executed by a processor 306 of the server 300. Thus, another event is the sending of a message to the server 300. For this purpose, the server 300 can have a data communication device 302 that is compatible with the data communication device 250 of the mobile device 200.

The data transfer connection 255 is not limited to communication between the mobile device 200 and the server 300. Rather, data transfer connections 255 can also be established with other mobile devices, traffic infrastructure devices, network storage devices and the like and can be monitored via at least one parameter profile and accordingly can be involved in the events (for example messages can be sent to these devices).

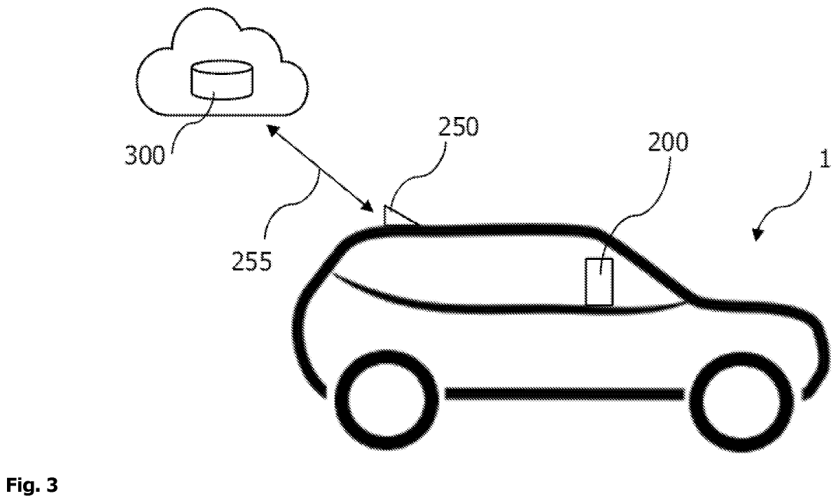

Finally, FIG. 3 schematically shows a vehicle 1 with a mobile device 200. The mobile device 200 can be the device 200 from FIG. 2. Of course, it does not have to be a mobile device 200, but the device 200 can also be permanently installed in the vehicle 1. As shown in FIG. 3, the data communication device 250 can be arranged separately from the mobile device 200 and coupled to it. The mobility of the device 200 is made possible here by the mobility of the vehicle 1.

It is understood that the embodiments described above are not exhaustive and do not limit the object disclosed here.

1. Method for controlling a data transfer for a mobile device (200), wherein the method comprises:
detecting (S10) a movement path of the mobile device (200);
ascertaining (S20) at least one parameter for a data transfer connection (255) along the movement path of the mobile device (200);
creating (S30) a parameter profile for each of the at least one parameter, wherein the parameter profile comprises a plurality of parameter values as a function of a position along the movement path and/or depending on a future point in time;
triggering (S40) an event as a function of the parameter profile.

2. Method according to claim 1, further comprising:
verifying (S35) whether one of the plurality of parameter values in the parameter profile is below a threshold value,
wherein the triggering of the event takes place:
at a point in time when the mobile device (200) reaches a position along the movement path associated with the parameter value lying below the threshold value, and/or
prior to the future point in time associated with the parameter value below the threshold value.

3. Method according to claim 1, wherein the at least one parameter comprises a transmission standard, a maximum data transmission speed, a transmission quality, a signal strength, and/or costs of the data transfer connection (255).

4. Method according to claim 1, wherein the event comprises:
activating a data transfer (255) to or from the mobile device (200);
outputting a notification to a user of the mobile device (200);
sending a message to a route planning module (230) that ascertains the movement path of the mobile device (200);
sending a message to a server (300), wherein the message comprises at least part of the parameter profile;
activating a buffer storage (280) which is designed to temporarily store data to be sent by the mobile device (200); and/or
sending a message to a system service (270).

5. Method according to claim 4, wherein the notification to the user comprises information for the user of the mobile device (200) about the parameter profile, and in particular about the parameter values as a function of the movement path and/or the time, and/or
wherein the notification to the user comprises information for the user of the mobile device (200) that, within a predetermined future portion of the movement path and/or within a predetermined future time span, the parameter values will be below a threshold value.

6. Method according to claim 5, wherein the system service (270) comprises a service for telephony, mailbox, answering machine, calendar, e-mail, text messages, and/or social media.

7. Method according to claim 6, wherein the system service (270) indicates an unavailability of the user of the mobile device (200) after receiving the message.

8. Method according to claim 1, wherein the detecting of a movement path comprises calculating a probability that the mobile device (200) will move along a potential movement path at a specific future point in time, and wherein the method is terminated for the potential movement path if the calculated probability is less than a threshold value.

9. Method according to claim 1, wherein ascertaining at least one parameter for the data transfer connection (255) along the movement path comprises obtaining (S25) extended map data (210), wherein the extended map data (210) contain location-related and/or time-related parameter values for the at least one parameter.

10. Mobile device (200) comprising:
a data communication device (250) which is designed to carry out a data transfer (255) on the basis of at least one transmission standard; and
a control unit (260) which is designed to carry out the method according to claim 1.

11. Vehicle (1) having a mobile device (200) according to claim 10.
